(19) United States
(12) Patent Application Publication
(10) Pub. No.: US 2016/0316954 A1
(43) Pub. Date: Nov. 3, 2016

(54) CUTTING TOOL AND METHODS OF USE THEREOF

(71) Applicant: MELONBLADE, LLC, Cumming, GA (US)

(72) Inventor: Anil MIDHA, Cumming, GA (US)

(73) Assignee: MELONBLADE, LLC, Cumming, GA (US)

(21) Appl. No.: 14/963,407

(22) Filed: Dec. 9, 2015

Related U.S. Application Data
(63) Continuation-in-part of application No. 29/544,700, filed on Nov. 5, 2015.
(60) Provisional application No. 62/155,320, filed on Apr. 30, 2015.
(60) Provisional application No. 62/160,696, filed on May 13, 2015.

(51) Int. Cl. A47J 17/02; B26B 3/00

(52) U.S. Cl. CPC A47J 17/02; B26B 3/00; A23L 1/2123; A23V 2002/00

(57) ABSTRACT

A cutting tool includes a generally elongate resiliently-flexible blade and a handle engaged with an elongate arm of the elongate blade and comprising a grasping portion. The elongate blade includes a cutting portion and a mounting portion. The cutting portion has a first cutting side and a second cutting side. The first cutting side includes a first angled cutting surface and the second cutting side includes a second angled cutting surface. In example forms, the first angled cutting surface includes a plurality of serrations formed thereon and the second angled cutting surface is substantially smooth. Preferably, the blade is substantially flexible to confirm to a melon rind for cutting and slicing the fruit therein.

### CROSS-REFERENCE TO RELATED APPLICATIONS

This application claims the benefit of U.S. Provisional Patent Application Ser. No. 62/155,320 filed Apr. 30, 2015, and U.S. Provisional Patent Application Ser. No. 62/160,696 filed May 13, 2015; and is a continuation-in-part of U.S. Design patent application Ser. No. 29/544,700, filed Nov. 5, 2015; the entireties of which applications are hereby incorporated herein by reference.

### TECHNICAL FIELD

The present invention relates generally to the field of cutlery and methods of use thereof, and more particularly to a cutting tool for cutting fruits such as melons, and to methods of slicing the same.

### BACKGROUND

Knives and cutting tools are commonly utilized for slicing fruits, for example, melons such as a watermelon, gourds, etc. Generally, a long-bladed knife or a chef's knife (which is typically serrated) is used whereby the melon is placed atop a cutting board and cut into two halves. The two halves are then cut into smaller sections (including the rind thereof). The smaller sections are then ready to store for consumption, or if desired, the smaller sections can be further cut whereby the melon flesh or fruit is removed from the rind and sliced into individual pieces for storage or consumption. This cutting method is often seen as a drawback due to being considerably time consuming. Furthermore, during the cutting thereof, juices from the watermelon typically spill on to the cutting board, the surface supporting the cutting board, the floor, etc., which causes further cleaning and time devoted to cleaning up the mess of the juices. In some cases, users by virtue of being aware of the associated time consumption, mess and post-cutting cleaning, result in choosing an easier-to-prepare fruit, or purchase pre-sliced watermelon from the local grocery.

Accordingly, it can be seen that needs exist for a cutting tool and methods thereof for preparing sliced fruit. It is to the provision of a cutting tool and methods of use thereof meeting these and other needs that the present invention is primarily directed.

### SUMMARY

In example embodiments, the present invention provides a cutting tool and methods of use thereof, for example, for preparing sliced fruit. In one aspect, the present invention relates to a cutting tool including a generally elongate blade and a handle engaged with an elongate arm of the elongate blade and comprising a grasping portion. In example forms, the handle includes a finger positioner and a recess formed within the finger positioner. The elongate blade includes a cutting portion and a mounting portion. The cutting portion has a first face, a second face, a first cutting side and a second cutting side. The first cutting side includes a first angled cutting surface defining a first cutting edge and the second cutting side includes a second angled cutting surface defining a second cutting edge. In example forms, the first angled cutting surface is generally defined between the first face and the first cutting edge and the second angled cutting surface is generally being defined between the second face and the second cutting edge. In example forms, the first angled cutting surface includes a plurality of serrations formed thereon such that the first cutting edge includes an array of radiused valleys extending therealong. The second, angled cutting surface is substantially smooth, and the mounting portion includes the elongate arm that is engaged with the handle.

In another aspect, the invention relates to a cutting tool for slicing a melon including a resiliently flexible blade member having a cutting portion and a mounting portion, and a handle mounted to the mounting portion of the blade member, the handle having a grasping portion for holding by a user. The cutting portion includes a first face and a second face. The second face is generally opposite the first face. In example forms, a first edge is provided on a first side of the cutting portion and a second edge is provided on a second side of the cutting portion. The first edge includes an array of radiused valleys formed thereon and the second edge being generally straight, wherein a first angled cutting surface is defined between the first face and the first edge and a second angled cutting surface is defined between the second face and the second edge. In example forms, the first and second angled cutting surfaces are generally oriented parallel with respect to each other.

In still another aspect, the invention relates to a method of preparing three-dimensional pieces of melon fruit including providing a melon, the melon having an outer melon rind generally substantially surrounding fruit therein, the melon rind generally having a curved inner surface and an elongate axis generally axially extending therethrough; providing a cutting tool, the cutting tool including a blade and a handle, the blade having a first face, a second face, a first cutting side, a second cutting side, a first cutting surface, a second cutting surface, an edge defined on each of the first and second cutting surfaces, and a rounded end generally extending between the first and second cutting sides; cutting the melon into two halves using the first cutting side of the blade, each half generally including an outer curved melon rind substantially containing fruit within the melon rind and generally attached thereto; making a plurality of generally parallel vertical slices into the fruit whereby the rounded end is generally moved along the inner curved surface of the melon rind, the vertical slices generally oriented both parallel and perpendicular relative to the elongate axis of the melon; making one or more generally angled slices through the fruit; and making a 360 degree cut with the second cutting surface in a clockwise direction whereby the blade generally conforms to the curvature of the curved inner surface of the melon rind such that the second face is generally positioned against the inner surface of the melon rind and with the edge of the first cutting surface at least partially offset from the inner surface of the melon rind to separate the fruit from the melon rind.

In yet another aspect, the invention relates to a cutting tool for cutting and slicing a melon to obtain three-dimensional pieces of the fruit contained within the melon, and whereby during the process thereof the juices created by the melon and fruit cutting and slicing substantially remain within the melon rind. The cutting tool includes a generally elongate blade having a cutting portion and a mounting portion. The mounting portion is engaged with a handle, and the handle includes a grasping portion for a user to grasp when in use. The cutting portion includes a first face, a second face, a first angled cutting surface and a second angled cutting surface. The first angled cutting surface is generally serrated along at least a portion of the elongate blade and defines a first angle with respect to the second face. The second angled cutting surface is generally straight along at least a portion of the elongate blade and defines a second angle with respect to the first face. The first and second faces are generally parallel relative to each other and the first and second angled cutting surfaces are generally parallel relative to each other. In example forms, the first and second angles are generally substantially similar with respect to each other.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a right side perspective view of a cutting tool according to an example embodiment of the present invention.

FIG. 2 is a left side perspective view of the cutting tool of FIG. 1.

FIG. 3 is a plan view of the right side of the cutting tool of FIG. 1.

FIG. 4 is an assembly view of the cutting tool of FIG. 3, showing a blade thereof being generally disconnected from a handle thereof.

FIG. 5 is a top view of the assembly view of FIG. 4.

FIG. 6 is a plan view of the blade of the cutting tool of FIG. 4.

FIG. 7 is a plan view of the blade of FIG. 6, showing the opposite side thereof.

FIG. 8 is a cross-sectional view of the blade of FIG. 6 taken along line 8-8.

FIG. 9 is a close-up perspective view of the blade of the cutting tool of FIG. 1.

FIG. 10 is a perspective cross-sectional view of a half of the handle of FIG. 5 taken along line 10-10.

FIG. 11 is a plan view of a blade cover for use with the cutting tool of FIG. 1 according to another example embodiment of the present invention.

FIG. 12 is a cross sectional view of the blade cover of FIG. 11 taken along line 12-12.

FIG. 13 is a cross sectional view of the blade cover of FIG. 11 taken along line 13-13.

FIG. 14 is a right side perspective view of a cutting tool according to another example embodiment of the present invention.

FIGS. 15-21 show a method of slicing a melon using the cutting tool of FIG. 1 according to another example embodiment of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

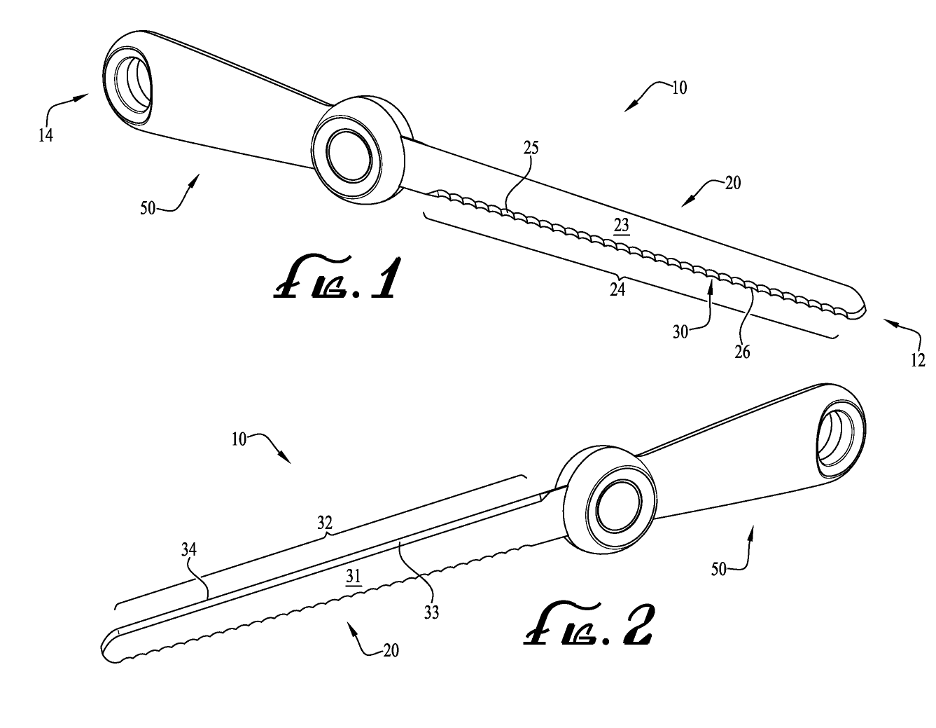

With reference now to the drawing figures, wherein like reference numbers represent corresponding parts throughout the several views, FIGS. 1-5 show a knife or cutting tool 10 according to an example embodiment of the present invention. In example forms, the cutting tool 10 is generally elongate and extends from a first end 12 to a second end 14, and generally comprises a blade 20 and a handle 50. According to example forms, the blade 20 and handle 50 are generally manufactured independently of each other and then assembled together to form the cutting tool 10. Optionally, as described according to some example embodiments of the present invention, the blade 20 and the handle 50 are generally integrally formed together as one piece, or for example, wherein the blade 20 is generally inserted into a mold such that the handle 50 (which is molded by the mold) is generally molded on the blade 20 to provide an integral connection therewith, for example, by an over-molding process.

According to example forms, the blade 20 is preferably formed from a generally flexible and resilient metal material, for example, 420 stainless steel, which is generally heat treated and tempered to HRC 44-48 (e.g., Rockwell Hardness Scale C), and then passivated to prevent any oxidation or rust to occur thereon. Optionally, the blade can be formed from other materials including plastics, composites, natural materials, synthetic materials, or combinations thereof. According to some alternative forms, the blade is formed from a plastic material comprising enough rigidity to provide for cutting the melon rind MR while having enough flexibility to conform to the shape or curvature of the melon rind MR when cutting the fruit F therein (as will be described below). Preferably, in the case of the alternative design where the blade is formed from a plastic material, the handle 50 would be formed from the same or similar plastic material, for example, as one integral piece, which would save additional manufacturing and assembly costs. Preferably in either case, the blade 20 is a food grade compliant material, for example, since the blade is intended for cutting through edible fruits such as melon. The handle 50 is generally formed from one or more food grade plastics, for example, a nylon material, which is optionally over molded by a food grade silicone for providing an improved griping surface. Optionally, other materials which may be beneficial for the user in gripping or grasping the handle 50 may be incorporated herein and should be recognized by one of ordinary skill in the art.

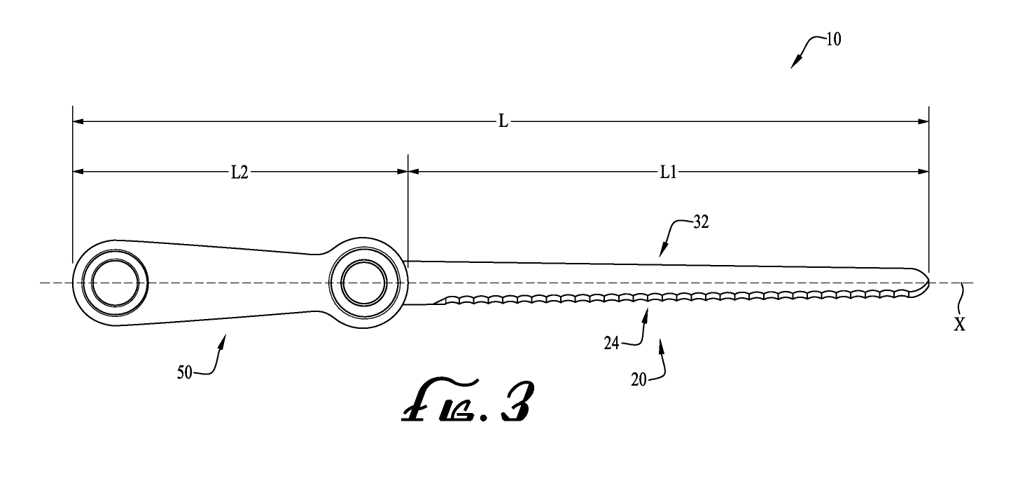

As depicted in FIGS. 1-2 and 4, the blade 20 generally comprises an elongate member having a cutting portion 22 and a mounting portion 40, for example, wherein the mounting portion 40 is generally positioned nearest to the handle 50 since it is generally intended that the mounting portion at least partially engage the handle to position the two relative to each other. The cutting portion 22 is preferably dual-sided or double-edged whereby either of a first cutting side 24 or a generally opposite second cutting side 32 may be directly engageable with the melon M for cutting or slicing. As depicted, the blade 20 and cutting portion 22 thereof comprise a first face 23 and a second face 31. For example, as depicted in FIGS. 1-2, the first face 23 defines a first cutting side 24 and the second face 31 defines a second cutting side 32 generally opposite the first cutting side 24.

The first cutting side 24 generally comprises a first angled cutting surface 25 extending between the first face 23 and a first cutting edge 26 and the second cutting side 32 generally defines a second angled cutting surface 33 extending between the second face 31 a second cutting edge 34. According to preferred forms, the first angled cutting surface 25 comprises a plurality of serrations 30 formed thereon, for example, between about 15-35 serrations, more preferably between about 22-32 serrations. As such, at least a portion of the first cutting edge 26 defines a generally longitudinal array of radiused valleys with generally sharp peaks (e.g., teeth) formed along the first angled cutting surface 25 and cutting edge 26 thereof, which according to some forms each of the serrations 30 comprises a pitch of about 6.35 millimeters and a depth of about 0.80 millimeters. Optionally, the serrations 30 can be sized as desired.

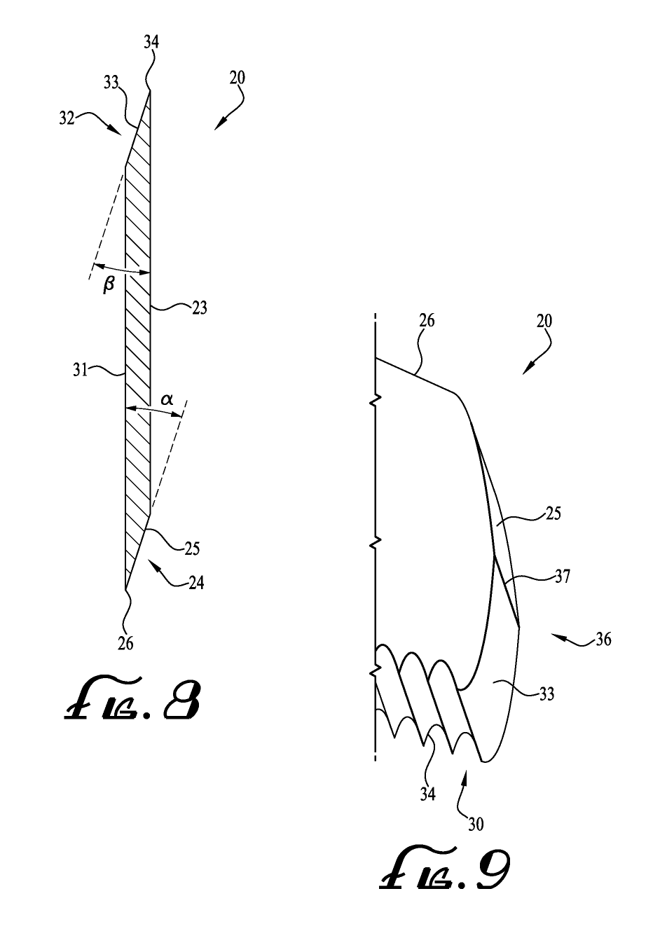

The second cutting side 32 is generally opposite the first cutting side 24 about a longitudinal axis X extending the length L of the cutting tool 10 (see FIG. 3). According to preferred example forms, the second angled cutting surface 33 and edge 34 thereof are substantially straight without serrations. Preferably, the edges 26 and 34 of the first and second angled cutting surfaces 25, 33 are substantially sharp and provide the cutting tool with a smooth and controlled cutting action, for example when cutting or slicing melon rinds MR or the fruit or melon flesh F therein. For example, as depicted in FIG. 8, the first angled cutting surface 25 is generally oriented at an angle α relative to the first face 23, and the second angled cutting surface 33 is generally oriented at an angle β relative to the second face 31. As such, the first and second angled cutting surfaces 25, 33 are generally equal and opposite in orientation, for example, whereby the angled surfaces 25, 33 are generally parallel to each other, for example, as the angles α and β are measured from different, generally parallel surfaces (e.g., first and second faces 23, 31). According to one example form, the angles α and β are each between about 12-26 degrees, more preferably between about 16-20 degrees, and more preferably about 18 degrees. Optionally, the angles α and β can be chosen as desired. Still referring to FIG. 8, the thickness T of the blade 20 is generally between about 0.50-1.25 millimeters, more preferably between about 0.65-1.0 millimeters, and more preferably about 0.81 millimeters. Preferably, the thickness of the blade 20 is generally configured to provide for adequate flexture thereof such that the blade 10 (or at least the cutting portion 22 thereof) can conform to the curvature of the melon rind MR.

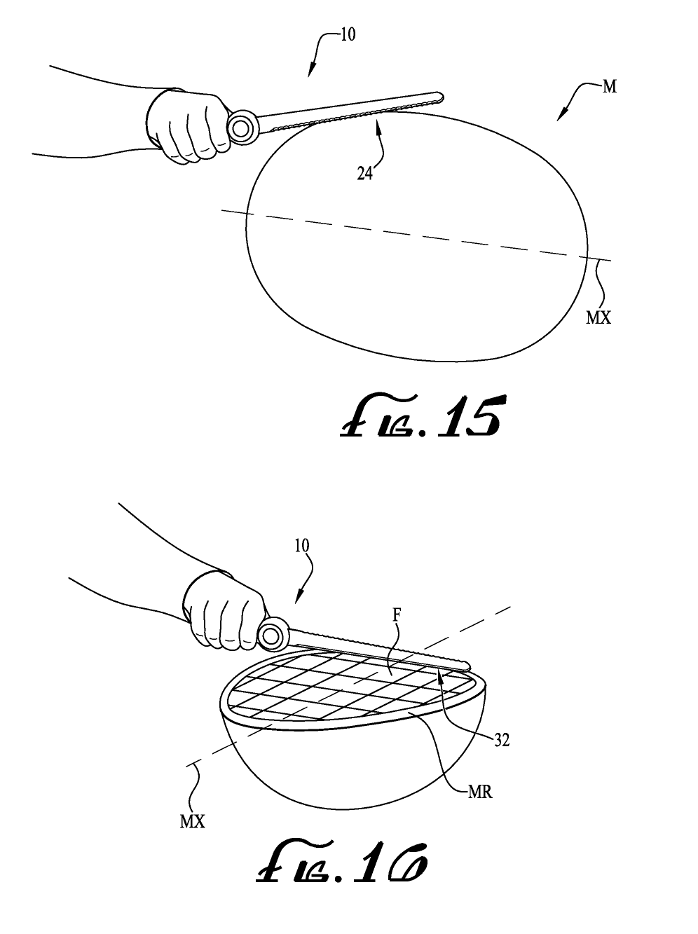

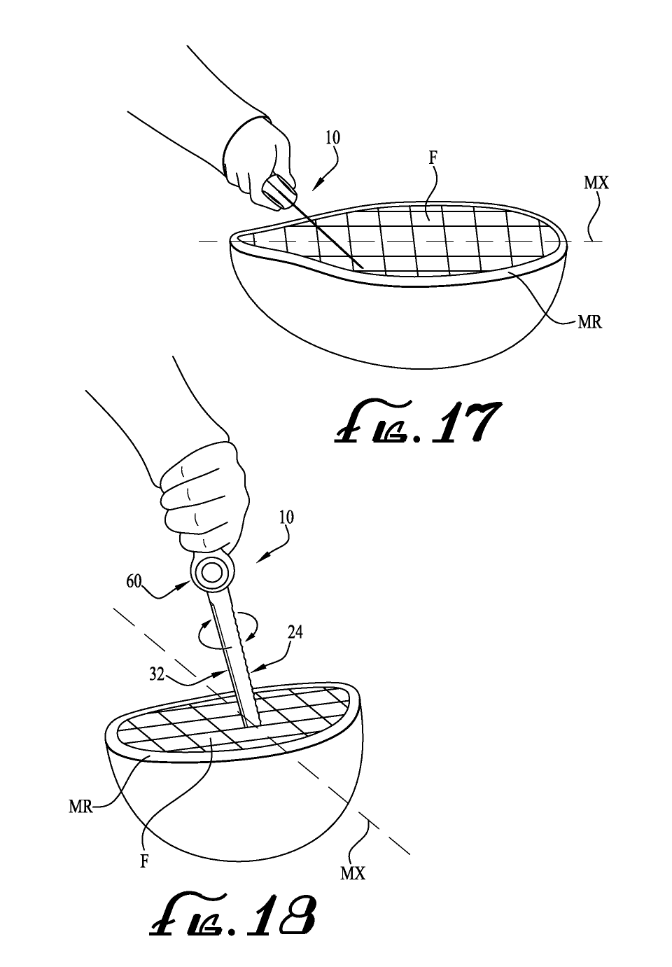

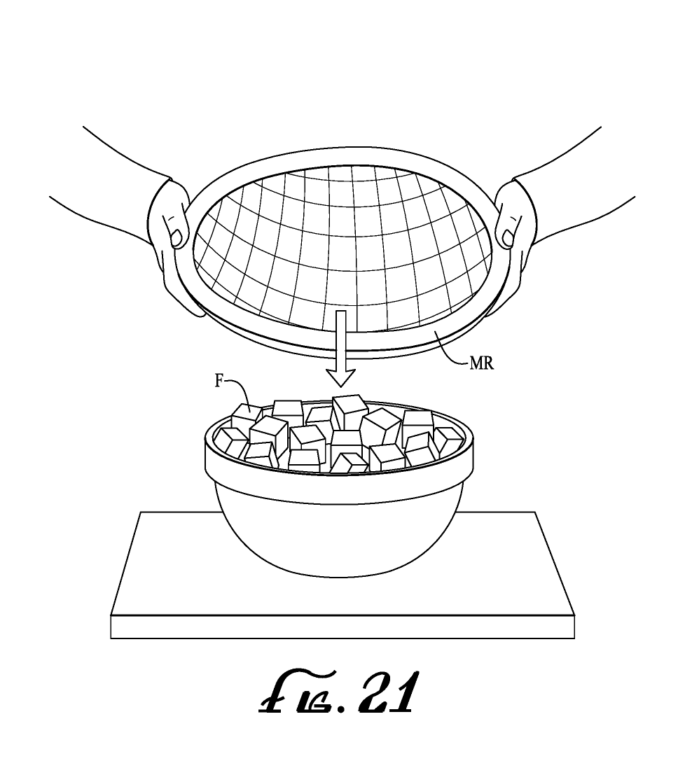

In example forms, the blade 20 is configured to be provided with enough rigidity and strength for cutting the melon in halves, for example, by using the serrated first cutting side 24 (e.g., wherein the melon is generally cut in to two pieces or halves about a longitudinal axis MX extending between the ends of the melon (see FIG. 15)). Furthermore, it is preferred that the blade 20 be rigid enough so that the second cutting side 32 is capable of making vertical, horizontal, and angled slices, for example, to slice through the fruit or melon flesh F to substantially relieve the melon flesh from connection with the melon rind (see FIGS. 16-17). Moreover, preferably the blade 20 as described herein comprises enough flexibility and resiliency such that the blade 20, and more preferably the cutting portion 22 thereof, can bend to have a radius R of curvature at its maximum bending point of between about 2-8 inches, more preferably between about 3-7 inches, and more preferably about 4 inches (see FIG. 20). For example, as depicted in FIGS. 19-20, the cutting portion of the blade 22 substantially conforms to the melon rind MR as the second cutting side 32 is being forced in a clockwise direction as the melon is stabilized and the second face 31 thereof is generally against the radiused melon rind MR. In example embodiments, the flexture of the cutting portion 22 substantially matches the contour of the internal portion of the melon rind MR, which is attached to the melon flesh F that is to be removed therefrom, for example, which is generally in chunks that are generally in the form of three dimensional pieces of melon fruit F that generally comprise two or more faces, and which are generally a product of cutting and slicing the melon (see FIG. 21). In example embodiments, the contour of the internal portion or the curved inner surface thereof generally comprises a radius of about 4 inches. For example, according to one example form, when the melon comprises an overall outer diameter of about 9 inches, the radius of curvature of the inner surface of the rind is about 4 inches. As would be obvious to one of ordinary skill in the art, as the overall maximum outer diameter of the melon is greater or less than 9 inches, the radius of curvature of the inner surface of the melon rind is generally about or slightly less than half the overall maximum diameter.

As depicted in FIG. 3, the cutting tool 10 comprises the length L, which is comprised of the length of the blade L1 and the length of the handle L2. In example forms, the length of the blade extending from the handle L1 is generally between about 125-250 millimeters, more preferably between about 160-235 millimeters, and more preferably between about 164.5-228.0 millimeters. For example, as depicted in FIG. 3, the length L1 is about 228 millimeters. However, as depicted in FIG. 14, the length L1 is about 164.5 millimeters. According to some example forms, the length L1 of the blade 20 may be referred to as the blade insertion depth, for example, since it is the length L1 defined between the first end 12 of the cutting tool 10 and the handle 50 that is insertable within the melon. The length L2 of the handle may be sized as desired. According to some example forms, the length L2 of the handle 50 is generally between about 130-160 millimeters, more preferably between about 140-150 millimeters, more preferably about 146.9 millimeters.

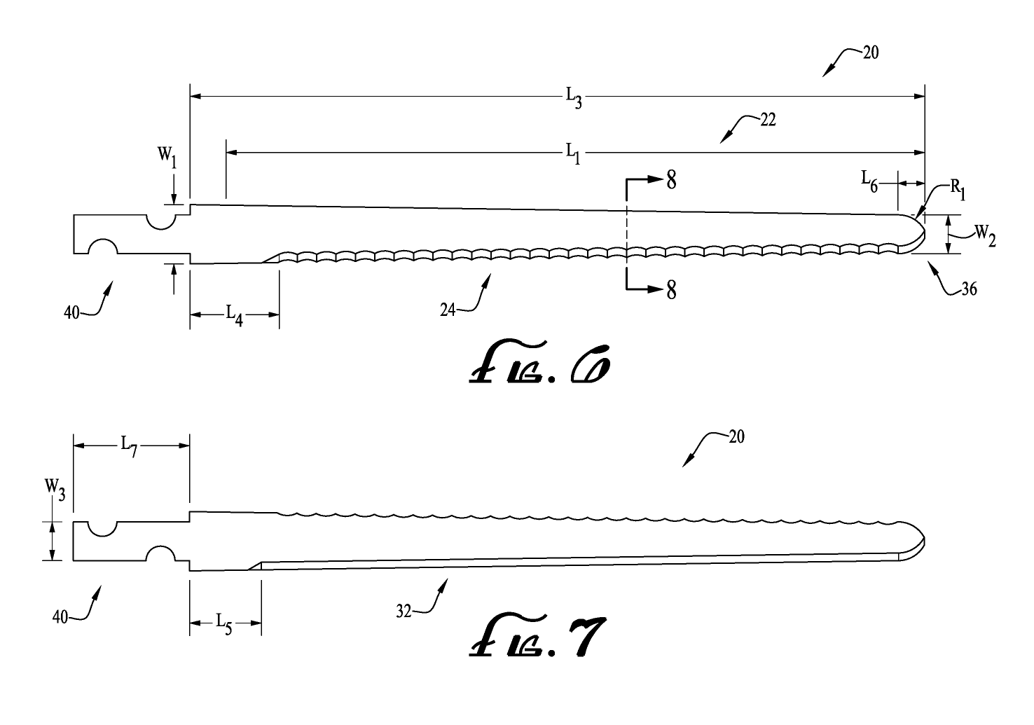

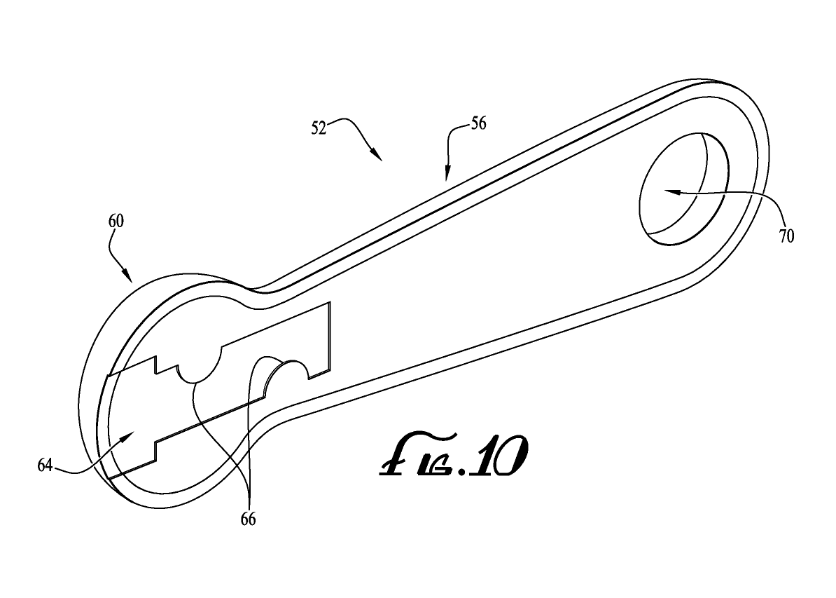

As depicted in FIGS. 6-8, the length L3 of the blade 20, which is measured from a rounded end 36 to the beginning of the mounting portion 40 is between about 160-255 millimeters, more preferably between about 170-250 millimeters, and more preferably between about 177-241 millimeters. As shown in FIGS. 6-7, the length L4 is defined between the beginning of the mounting portion 40 and the start of the serrated first cutting side 24, and the length L5 is defined between the beginning of the mounting portion 40 and the start of the second cutting side 32. In example forms, the length L4 is between about 20-40 millimeters, more preferably between about 25-35 millimeters, and more preferably about 29.20 millimeters. The length L5 is generally between about 15-40 millimeters, more preferably between about 20-30 millimeters, and more preferably between about 23.54-29.20 millimeters. Referring back to FIG. 6, the length L6 is generally defined between the end of the cutting sides 24, 32 and the rounded end 36 of the blade, which is generally between 7-10 millimeters, more preferably between about 8-9 millimeters, and more preferably between about 8.3-8.4 millimeters. In example forms, the rounded end 36 is generally radiused to comprise a radius R1 of between about 8-12 millimeters, more preferably about 10 millimeters. As shown in FIG. 9, the first and second cutting surfaces 25, 33 generally extend around the rounded end 36 and generally converge together to define an edge 37. According to some forms, the edge 37 is generally subtle and provides for a smooth transition between the first and second cutting surfaces 25, 33, for example, so that the rounded end 36 can move smoothly along the melon rind MR when slicing the fruit F (see FIGS. 16-17). Optionally, other transitions or edges may be formed as desired.

Referring back to FIGS. 6-7, the blade 20 defines a first width W1 where the mounting portion 40 intersects with the blade portion 22, a second width W2 generally near the rounded end 36, and a third width W3 at the mounting portion 40. According to example forms, the first width W1 is generally between about 17-22 millimeters, more preferably about 19.4 millimeters, the second width W2 is generally between about 10-14 millimeters, more preferably about 12.7 millimeters, and the third width W3 is generally between about 10-14 millimeters, more preferably about 12.7 millimeters. According to example forms, the mounting portion 40 defines a length L7 of between about 36-40 millimeters, more preferably about 38.10 millimeters.

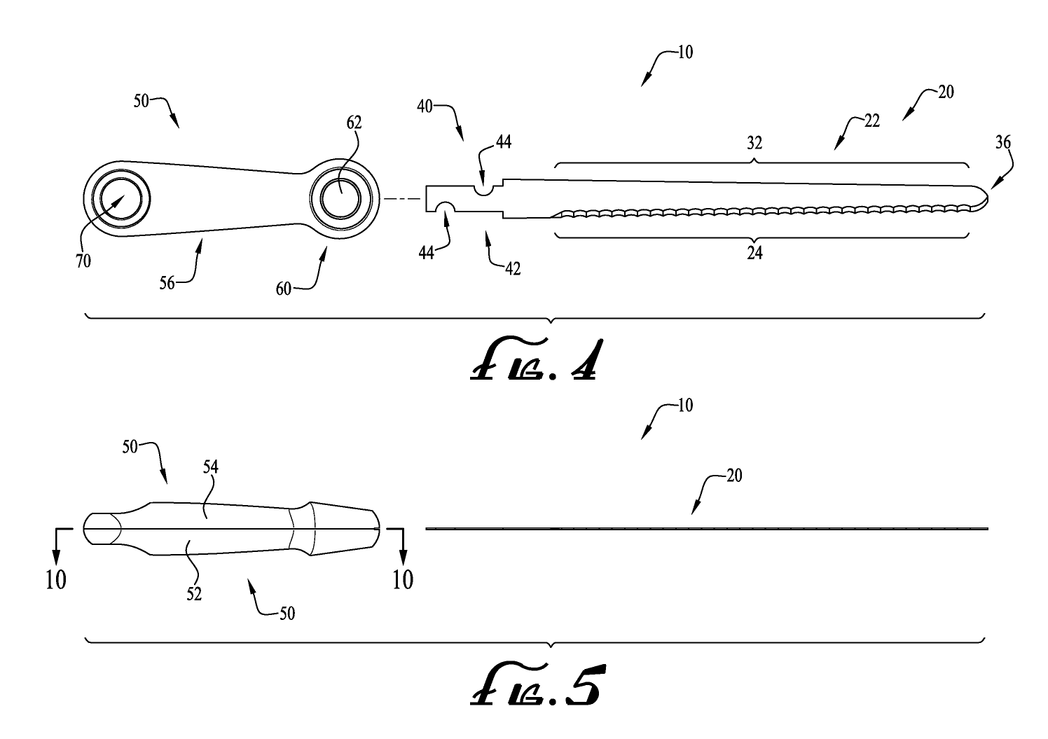

As shown in FIGS. 4-5 and 10, the handle 50 generally comprises a first half 52 and a second half 54, which are generally coupled together to form the handle 50. As described above, according to some example forms, the handle 50 is generally formed from one or more food grade plastics, for example, a nylon material, which is optionally over molded by a food grade silicone for providing an improved griping surface. Thus, according to example forms, the handle halves 52, 54 are generally each molded from a nylon material and then each over-molded with a silicone material. The halves 52, 54 can then be positioned on opposite sides of the blade 20 (e.g., the mounting portion 40 thereof), and then coupled together to cause engagement between the halves 52, 54 and the mounting portion 40. In example embodiments, the handle 50 comprises a grasping portion 56, a finger positioner 60 (comprising a recess 62 therein), a blade receiver 64 for receiving the mounting portion 40, and an end opening 70. As will be described below, the grasping portion 56 is configured to be grasped by one or more hands of a user, and the finger positioner 60 and recess 62 thereof are configured for receiving a thumb or other finger of the user to facilitate in grasping and orienting the knife 10 properly when cutting.

As shown in FIGS. 4 and 10, the mounting portion 40 of the blade 20 generally comprises the elongate arm 42 and one or more cutouts 44 for providing interengagement with the blade receiver 64 of the handle 50. For example, according to one example form, the elongate arm 42 generally comprises a pair of cutouts 44, for example, with one of the cutouts 44 formed on one side of the arm 42 and the other cutout 44 formed on the other side of the arm 42. In example forms, the cutouts 44 are generally semi-circular in shape, however, other shapes, features, etc. may be provided as desired. Similarly, as depicted in FIG. 10, the blade receiver 64 comprises a pair of interengagement features 66, which are generally complementary in shape to the cutouts 44, to provide for interengagement with the cutouts 44 when the elongate arm 42 of the mounting portion 40 is seated within the blade receiver 64. Alternatively, as described above, the handle 50 can be one unitary piece and the elongate arm 42 of the mounting portion 40 can be present and positioned within the mold when molding the handle 50, for example, so that the elongate arm 42 is permanently attached to the handle 50.

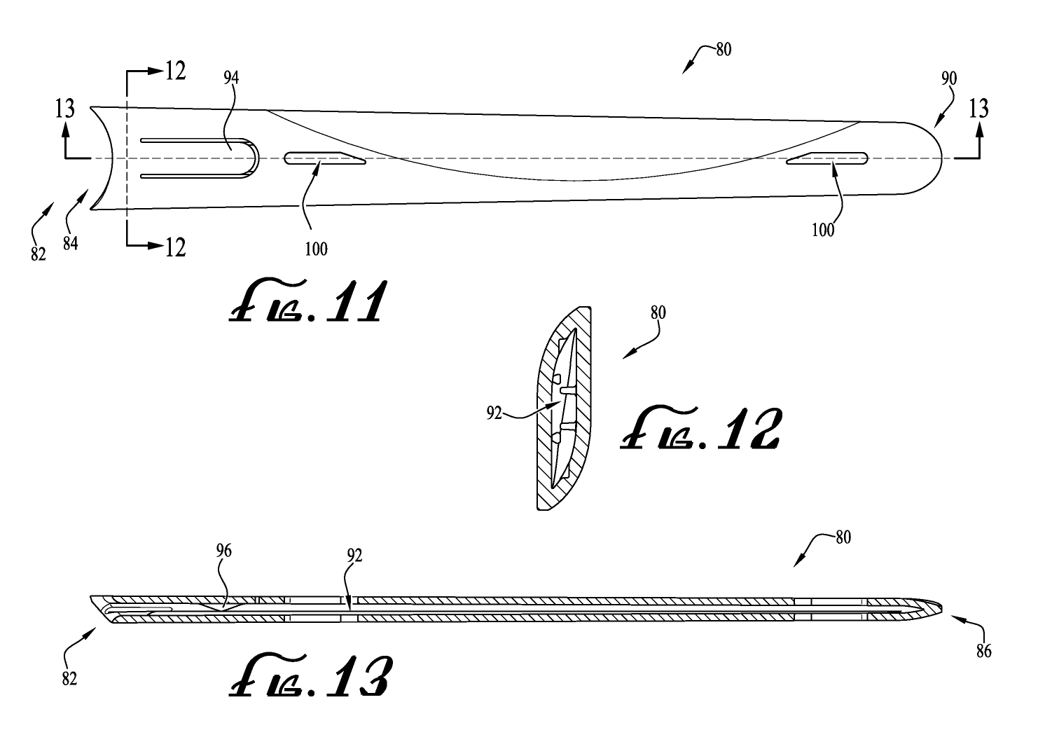

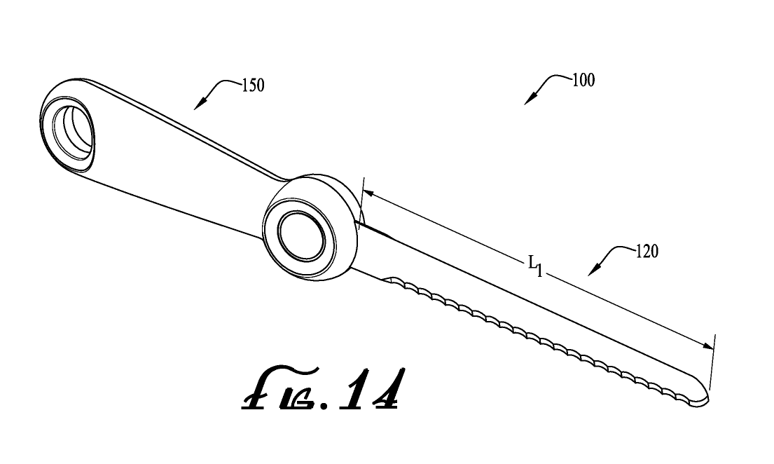

According to example embodiments, a sheath or protective cover 80 can be provided for covering the blade 20 or at least the cutting portion 22 thereof when the cutting tool 10 is not in use or stored in a drawer or cabinet. As depicted in FIGS. 11-13, the cover 80 generally extends from a first open end 82 to a second closed end 86. As shown in FIG. 11, the first open end 82 comprises a curved concaved profile 84, which is preferably curved similarly to the finger positioner 60, for example, for seating thereagainst when the cutting portion 22 is generally fully captured within cover 80; and the second closed end 86 comprises a curved convex profile 90 that is curved to substantially match the rounded end 36. The cover 80 comprises an internal cavity 92 that is generally sized to receive at least the cutting portion 22 of the blade 20, for example, whereby at least the entirety of the blade 20 that is not engaged with the handle 50 is generally capable of being positioned within the cavity 92. According to some example forms, one or more fingers 94 may be formed on portions of the cover 80 to provide for engagement with the blade 20, for example, to provide frictional engagement therewith such that the cover 80 remains engaged with the blade 20. Accordingly, one or more ribs 96 may be formed on the one or more fingers 94 or along portions of the internal cavity 92 to provide additional engagement with the blade 20. Furthermore, one or more openings 100 may be formed through at least a portion of the cover 80 (e.g., through an external portion thereof to at least the internal cavity 92) to allow the blade 20 to breathe, for example, so that any moisture on the blade 20 is allowed to evaporate and not prevent mold or mildew thereon.

FIG. 14 shows a cutting tool 100 according to another example embodiment of the present invention. As discussed above, the cutting tool 100 is substantially similar to the cutting tool 10 as disclosed above. Preferably, the length L1 of the blade 120 is generally shorter than the length L1 of the blade 10. For example, the length L1 of the blade 100 is generally about 164.5 millimeters. However, as discussed above, the length L1 can generally be between about 125-250 millimeters, more preferably between about 160-235 millimeters, and more preferably between about 164.5-228.0 millimeters.

According to another example form, the present invention relates to a method of cutting a melon M using the cutting tools 10, 100 of the present invention. For example, as depicted in FIGS. 15-21, a user can be provided with a cutting tool 10 to quickly and easily separate melon fruit F from the melon rind MR. According to example forms, the melon M is generally in the form of a watermelon. However, the melon can be in the form of other melons, fruits, etc., for example, where there is a need to separate the melon fruit from the rind thereof. As depicted in FIG. 15, the user generally takes the cutting tool 10 by holding the grasping portion 56 with their hand, and by using the first cutting side 24 (e.g., serrated side), the user cuts the melon M into two halves. Typically, the user will use a back-and-fourth cutting motion to allow for the serrations of the first cutting side 24 to cut through the melon rind MR and the fruit F therein. As depicted, the user generally cuts the melon M along a generally elongate axis MX extending the length of the melon M and that is generally axial with the elongate extension thereof. With the melon cut into two halves, the user then puts one of the halves aside and begins the cutting process for the other one of the halves.

As depicted in FIG. 16, the user makes a plurality of vertical slices through the fruit F that is present within the melon rind MR (e.g., from the exposed surface of the fruit to the portion in contact with the melon rind MR). For example, by using the second cutting side 32, the user slides the cutting portion 22 of the blade 20 within the fruit F whereby the rounded end 36 generally rides along the contour of the melon rind MR, from one side of the rind to the other in a direction generally perpendicular to the elongate axis MX. The user preferably makes a plurality of parallel slices along the elongate axis MX. The user then rotates the melon half 90 degrees and performs the same parallel slices, thereby forming a checkerboard or crisscross pattern. Typically, the number of slices will generally depend on the size of the melon, and the distance between the slices will generally be between about 1-7 millimeters, more preferably between about 2.5-4.5 millimeters.

As depicted in FIG. 17, the user then makes a plurality of angled slices through the melon fruit F, for example, from the exposed portion of the fruit to where the fruit is in contact with the melon rind MR to further slice the fruit F into smaller cubes or generally three-dimensional pieces. The number of angled slices can vary, but preferably at least one angled slice is performed. Typically, the blade 10 is generally oriented at an angle of between about 5-45 degrees relative to the exposed surface of the fruit F when performing the angled slices. Alternatively, the angle defined between the blade and the exposed surface of the fruit can be chosen as desired.

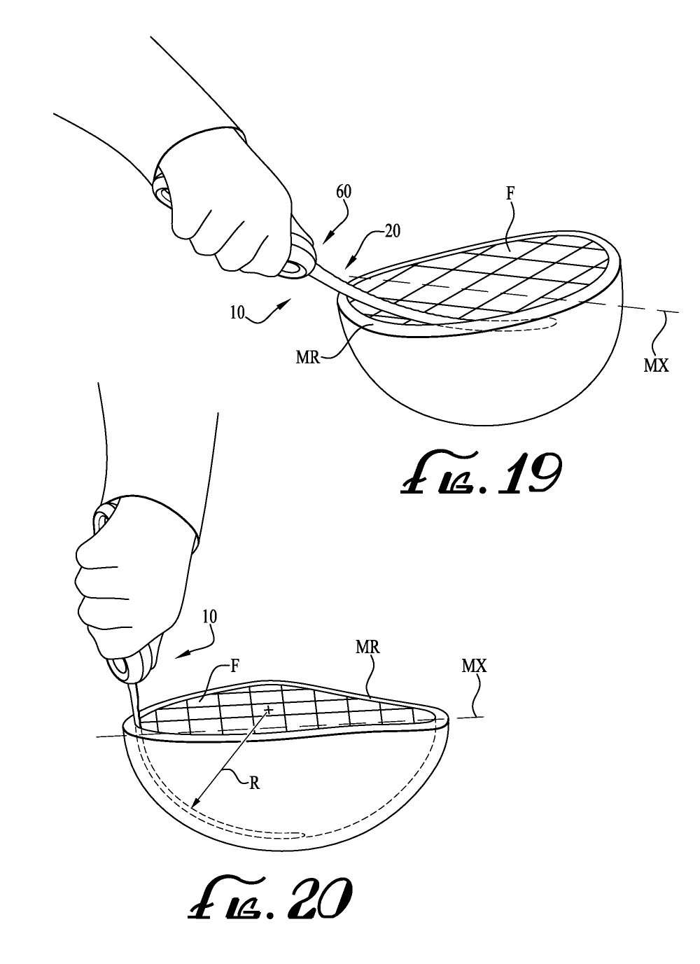

Once the vertical and angles slices are complete, the user then performs a 360 degree cut (as will be described below) around the melon rind MR and the fruit F, for example, such that the fruit F can be separated from the melon rind MR. As depicted in FIG. 18, with the user's hand gripping the grasping portion 56 of the handle 50 and with their thumb generally positioned within the recess 62 of the finger positioner 60, the user generally inserts the blade in a vertical manner within the center of the fruit F until the rounded end 36 contacts the melon rind MR. The user then begins to move the blade 10 in a clockwise direction (see direction arrow) while generally stabilizing the melon half with their other hand. Preferably, as the blade moves in the clockwise direction, the user generally begins with an angled approach (see FIG. 19) towards the curved inner surface of the melon rind MR until the blade 20 is substantially in a flexed state whereby the blade 20 (or at least the second cutting side 32 of the cutting portion 22 thereof) conforms to the curved inner surface of the melon rind MR (see FIG. 20). The user continues rotating the blade 20 in the clockwise direction while generally stabilizing the melon half until the blade 20 has completed 360 degrees of rotation around the melon rind MR with the blade 20 substantially curved or flexed to conform to the inner surface of the melon rind MR, thereby separating the fruit F from the melon rind MR at the approximate location where the two are connected. Alternatively, the user may generally rotate the melon half in a counter-clockwise direction as the blade 20 is moved in the clockwise direction. Preferably, by providing flexture to the blade 20 such that the same can substantially confirm to the curvature of the inner surface of the melon rind MR, the fruit can be sliced and removed from the melon rind MR much more efficiently and in a timely manner. As depicted in FIG. 21, after the user finishes performing the 360 degree cut (e.g., separating the fruit F from the melon rind MR), the user can then empty the loose fruit F (generally three-dimensional pieces or cubes of fruit) from within the melon rind MR into a storage container or bowl B for storage or consumption.

According to example forms, during the 360 degree cut, the blade 20 of the cutting tool 10 and the clockwise cutting direction is preferably configured so that the edge 34 of the second cutting surface is generally offset from the inner surface of the melon rind MR by at least the thickness T of the blade 20. For example, since the user performs a 360 degree cut around the inner surface of the melon rind in a clockwise direction with the second cutting side 32, the edge 34 will not be present directly against the inner surface of the melon rind, and thus, is less likely to catch against the rind or cause unintended interference therewith. Rather, the second face 31 will generally be directly against the curved inner surface of the melon rind MR. Optionally, to further facilitate cutting the fruit from the melon rind MR during the 360 degree cut in the clockwise direction, one or more surface treatments, additives, anti-friction coatings, spacers, etc. may be provided to further decrease any frictional engagement between the second cutting side 32 (including the second face 31, cutting surface 33 and edge 34 thereof) and the inner surface of the melon rind MR.

Alternatively, as coarse fruit may require, and according to other example embodiments of the present invention, the 360 degree cut may be performed in so that the edge 26 of the first cutting surface (and thus serrations 30 thereof) is generally offset from the inner surface of the melon rind MR by at least the thickness T of the blade 20. For example, since the user performs a 360 degree cut around the inner surface of the melon rind in a clockwise direction with the first cutting side 24, the edge 26 will not be present directly against the inner surface of the melon rind, and thus, is less likely to catch against the rind or cause unintended interference therewith. Rather, the first face 23 will generally be directly against the curved inner surface of the melon rind MR. The user may use an up-and-down slicing motion to allow for the serrations 30 of the first cutting side 24 to separate the melon rind MR and the fruit F therein. Optionally, to further facilitate cutting the fruit from the melon rind MR during the 360 degree cut in the clockwise direction, one or more surface treatments, additives, anti-friction coatings, spacers, etc. (as described above) may be provided to further decrease any frictional engagement between the first cutting side 24 (including the first face 23, cutting surface 25 and edge 26 thereof) and the inner surface of the melon rind MR. Alternatively, according to other example embodiments of the present invention, the 360 degree cut may be performed in a counter-clockwise direction such that the edge 34 is generally directly against the inner surface of the melon rind MR. Furthermore, according to other example forms, the first cutting side 24 (including the cutting surface 25 and edge 26 thereof) may alternatively be used for performing the 360 degree cut in either of the clockwise or counter-clockwise directions.

In additional example embodiments, the present invention relates to a method of slicing a melon or preparing three-dimensional pieces of melon fruit. The method includes providing a melon, the melon comprising an outer melon rind MR generally substantially surrounding fruit F therein, the melon rind generally comprising a curved inner surface and an elongate axis generally axially extending therethrough; providing a cutting tool, the cutting tool comprising a blade 20 and a handle 50, the blade comprising a first face 23, a second face 31, a first cutting side 24, a second cutting side 32, a first cutting surface 25, a second cutting surface 33, edges 26, 34 defined on the first and second cutting surfaces 25, 33, and a rounded end 36; cutting the melon into two halves using the first cutting side 24 of the blade 20, each half generally comprising an outer curved melon rind substantially containing fruit within the melon rind and generally attached thereto; making a plurality of generally parallel vertical slices into the fruit whereby the rounded end 36 is generally moved along the inner curved surface of the melon rind, the vertical slices generally oriented both parallel and perpendicular relative to the elongate axis of the melon; making one or more generally angled slices through the fruit; and making a 360 degree cut with the second cutting surface in a clockwise direction whereby the blade generally conforms to the curvature of the curved inner surface of the melon rind such that the second face 31 is generally positioned against the inner surface of the melon rind and with the edge of the first cutting surface at least partially offset from the inner surface of the melon rind to separate the fruit from the melon rind.

While the invention has been described with reference to preferred and example embodiments, it will be understood by those skilled in the art that a variety of modifications, additions and deletions are within the scope of the invention, as defined by the following claims.

What is claimed is:

1. A cutting tool comprising:
a generally elongate blade comprising a cutting portion and a mounting portion, the cutting portion comprising a first face, a second face, a first cutting side and a second cutting side, the first cutting side comprising a first angled cutting surface defining a first cutting edge and the second cutting side defining a second angled cutting surface defining a second cutting edge, the first angled cutting surface generally defined between the first face and the first cutting edge and the second angled cutting surface generally being defined between the second face and the second cutting edge, the first angled cutting surface comprising a plurality of serrations formed thereon such that the first cutting edge comprises an array of radiused valleys extending therealong, the second angled cutting surface being substantially smooth, the mounting portion comprising an elongate arm; and
a handle engaged with the elongate arm of the elongate blade and comprising a grasping portion, a finger positioner, and a recess formed within the finger positioner.

2. The cutting tool of claim 1, wherein the first and second angled cutting surfaces are generally oriented parallel with respect to each other.

3. The cutting tool of claim 1, wherein the first angled cutting surface is oriented at an angle of between about 16-20 degrees relative to the second face.

4. The cutting tool of claim 3, wherein the first angled cutting surface is oriented at an angle of about 18 degrees relative to the second face.

5. The cutting tool of claim 1, wherein the second angled cutting surface is oriented at an angle of between about 16-20 degrees relative to the first face.

6. The cutting tool of claim 5, wherein the second angled cutting surface is oriented at an angle of about 18 degrees relative to the first face.

7. The cutting tool of claim 1, wherein the blade defines a blade insertion depth of between about 164.5-228.0 millimeters.

8. The cutting tool of claim 1, wherein the blade comprises a thickness of between about 0.65-1.0 millimeters.

9. The cutting tool of claim 8, wherein the blade comprises a thickness of about 0.81 millimeters.

10. The cutting tool of claim 1, wherein the blade is resiliently flexible such that the blade can conform to a curved inner surface of a melon rind having a radius of curvature of about 4 inches.

11. The cutting tool of claim 10, wherein the blade at its maximum bending position comprises a radius of curvature of about 4 inches.

12. The cutting tool of claim 1, wherein the handle is formed from a food grade nylon material and the blade is formed from 420 stainless steel.

13. A cutting tool for slicing a melon comprising:
a resiliently flexible blade member comprising a cutting portion and a mounting portion, the cutting portion comprising a first face and a second face, the second face generally opposite the first face, a first edge being provided on a first side of the cutting portion and a second edge being provided on a second side of the cutting portion, the first edge comprising an array of radiused valleys formed thereon and the second edge being generally straight, wherein a first angled cutting surface is defined between the first face and the first edge and a second angled cutting surface is defined between the second face and the second edge, the first and second angled cutting surfaces generally being oriented parallel with respect to each other; and
a handle mounted to the mounting portion of the blade, the handle comprising a grasping portion for holding by a user.

14. The cutting tool of claim 13, wherein the first angled cutting surface is oriented at an angle of about 18 degrees relative to the second face, the second face being generally parallel with respect to the first face.

15. The cutting tool of claim 13, wherein the second angled cutting surface is oriented at an angle of about 18 degrees relative to the first face, the first face being generally parallel with respect to the second face.

16. The cutting tool of claim 13, wherein the blade defines a blade insertion depth of between about 164.5-228.0 millimeters.

17. The cutting tool of claim 13, wherein the blade defines a blade insertion depth of about 228.0 millimeters.

18. The cutting tool of claim 13, wherein the blade comprises a thickness of about 0.81 millimeters.

19. The cutting tool of claim 13, wherein the blade is resiliently flexible such that the blade can conform to a curved inner surface of a melon rind having a radius of curvature of about 4 inches.

20. The cutting tool of claim 10, wherein the blade at its maximum bending position comprises a radius of curvature of between about 2-8 inches.

21. The cutting tool of claim 13, wherein the handle is formed from a food grade nylon material and the blade is formed from 420 stainless steel.

22. A method of preparing three-dimensional pieces of melon fruit comprising:
providing a melon, the melon comprising an outer melon rind generally substantially surrounding fruit therein, the melon rind generally comprising a curved inner surface and an elongate axis generally axially extending therethrough;
providing a cutting tool, the cutting tool comprising a blade and a handle, the blade comprising a first face, a second face, a first cutting side, a second cutting side, a first cutting surface, a second cutting surface, an edge defined on each of the first and second cutting surfaces, and a rounded end generally extending between the first and second cutting sides;
cutting the melon into two halves using the first cutting side of the blade, each half generally comprising an outer curved melon rind substantially containing fruit within the melon rind and generally attached thereto;
making a plurality of generally parallel vertical slices into the fruit whereby the rounded end is generally moved along the inner curved surface of the melon rind, the vertical slices generally oriented both parallel and perpendicular relative to the elongate axis of the melon;
making one or more generally angled slices through the fruit; and
making a 360 degree cut with the second cutting surface in a clockwise direction whereby the blade generally conforms to the curvature of the curved inner surface of the melon rind such that the second face is generally positioned against the inner surface of the melon rind and with the edge of the first cutting surface at least partially offset from the inner surface of the melon rind to separate the fruit from the melon rind.

23. A cutting tool for cutting and slicing a melon to obtain three-dimensional pieces of the fruit contained within the melon, and whereby during the process thereof the juices created by the melon and fruit cutting and slicing substantially remain within the melon rind, the cutting tool comprising a generally elongate blade comprising a cutting portion and a mounting portion, the mounting portion being engaged with a handle, the handle comprising a grasping portion for a user to grasp when in use, the cutting portion comprising a first face, a second face, a first angled cutting surface and a second angled cutting surface, the first angled cutting surface being generally serrated along at least a portion of the elongate blade and defining a first angle with respect to the second face, the second angled cutting surface being generally straight along at least a portion of the elongate blade and defining a second angle with respect to the first face, the first and second faces being generally parallel relative to each other and the first and second angled cutting surfaces being generally parallel relative to each other, and whereby the first and second angles being generally substantially similar with respect to each other.
